(19) United States
(12) Patent Application Publication
(10) Pub. No.: US 2007/0201782 A1
(43) Pub. Date: Aug. 30, 2007

(54) Seal device and rolling bearing unit with seal device

(76) Inventors: Takayuki Miyagawa, Kanagawa (JP); Hiromitsu Asai, Kanagawa (JP)

Correspondence Address: SUGHRUE-265550, 2100 PENNSYLVANIA AVE. NW, WASHINGTON, DC, 20037-3213, US

(21) Appl. No.: 11/704,993

(22) Filed: Feb. 12, 2007

(30) Foreign Application Priority Data
Feb. 10, 2006 (JP) P.2006-033483
Jan. 18, 2007 (JP) P.2007-009229

(51) Int. Cl. F16J 15/00; F16C 33/76

(52) U.S. Cl. 384/486; 277/351

(57) ABSTRACT

A distal edge of an outside seal lip 22a is brought into sliding contact with an entire circumference of the surface of a mating member. A contact angle β that is formed at a sliding contact portion between the distal edge of the outside seal lip 22a and the mating member on the side of an interior space 33 is made to fall within a range of 13 to 45 degrees by providing a bent portion 34 at a portion on the outside seal lip 22a which lies closer to a distal end thereof.

### BACKGROUND OF THE INVENTION

1. Field of the Invention

The present invention relates to a seal device for closing an opening end portion of a rolling bearing which is built in a rotational support portion of various types of mechanical apparatuses such as a road wheel supporting rolling bearing unit for supporting a road wheel on a suspension system of, for example, a vehicle (a motor vehicle), and an improvement of a bearing unit with a seal device which includes the seal device. To be specific, the invention is intended to increase the sealing performance, that is, a performance of preventing the intrusion of foreign matters such as mud and water into an interior space in which rolling elements are provided and a performance of preventing the leakage of grease sealed in the interior space therefrom to the outside and to realize the reduction in friction and wear so as to increase the running performance of the vehicle mainly in the areas of fuel economy and acceleration and the durability of the seal device.

2. Description of Related Art

Rolling bearings such as ball bearings, cylindrical roller bearings and tapered roller bearings are built in rotational support portions of various types of mechanical apparatuses. A seal device is built in such a rolling bearing to prevent the leakage of grease sealed in an interior space in the rolling bearing therefrom to the outside and to prevent the intrusion of foreign matters such as rain water, mud and dust which exist outside into the interior of the rolling bearing. FIG. 18 shows as an example of a rolling bearing unit with a seal device which includes the seal device described above a construction for supporting rotatably a road wheel on a suspension system of a vehicle.

The rolling bearing unit with a seal device is made up of an outer ring 1 which is an outer ring corresponding member, a hub 2 which is an inner ring corresponding member and a plurality of rolling elements 3, 3. Among these constituent components, the hub 2 is made up of a combination of a hub main body 4 and an inner ring element 5. In addition, the rolling elements 3, 3 are provided between double outer ring raceways 6, 6 formed on an inner circumferential surface of the outer ring 1 and double inner ring raceways 7, 7 formed on an outer circumferential surface of the hub 2 in such a manner as to freely roll therebetween, with a row of a plurality of rolling elements fitted in each of the pairs of raceways. When in use, that is, when rotatably supporting the road wheel on the suspension system, the outer ring 1 is fixed to a knuckle 8 which makes up the suspension system, and the road wheel is fixedly connected to a mounting flange 9 provided on the hub main body 4. In addition, since the construction shown in FIG. 18 is a construction for supporting a drive wheel, a splined shaft 12, which is an accessory component of a constant velocity joint 11, is brought into engagement with a splined hole 10 provided in a central portion of the hub main body 4.

In the rolling bearing unit with a seal device which includes seal rings that has been described above, grease is sealed in an interior space 13 in which the rolling elements 3, 3 are placed so as to lubricate rolling contact portions between rolling surfaces of the rolling elements 3, 3 and the outer ring raceways 6, 6 and the inner ring raceways 7, 7. In addition, seal rings 14a, 14b are provided between inner circumferential surfaces of both end portions of the outer ring 1 and an outer circumferential surface of an inner end portion of the inner ring element 5 and an outer circumference of an intermediate portion of the hub main body 4, respectively, so as to close both end openings of the interior space 13.

Of these seal rings 14a, 14b, the seal ring 14a which closes an inner end opening of the interior space 13 is configured as is shown in FIG. 19. (Here, “inner” with respect to the axial direction denotes a side which is to lie more inwards in a transverse direction of the vehicle in such a state that the rolling bearing unit is built in the vehicle, that is, the right side in FIG. 18. On the contrary, a side which is to lie more outwards in the transverse direction of the vehicle, that is, the left side in FIG. 18 is referred to as “outer.” This holds true throughout the specification.)

This seal ring 14a is such as to be referred to as an assembled seal ring and is made up of a core metal 15, a slinger 16 and a seal member 17. Among these constituent components, the core metal 15 includes a diametrically outside cylindrical portion 18 which is made to fixedly fit in the inner circumferential surface of the end portion of the outer ring 1 and a diametrically outside circular ring portion 19 which is bent inwards in a diametrical direction from an axial outer edge of the diametrically outside cylindrical portion 18 and hence is formed into an annular shape as a whole which has an L-shaped cross section.

In addition, the slinger 16 includes a diametrically inside cylindrical portion 20 which is made to fixedly fit on the outer circumferential surface of the end portion of the inner ring element 5 and a diametrically inside circular ring portion 21 which is bent outwards in the diametrical direction from an axial inner edge of the diametrically inside circular ring portion 20 and hence is formed into an annular shape as a whole which has an L-shaped cross section. In addition, the seal member 17 is made of an elastic material such as an elastomer like a rubber, includes three outside, intermediate and inside seal lips 22 to 24 and is fixedly connected to the core metal 15 at a proximal end portion thereof. Then, a distal edge of the outside seal lip 22, which is referred to as a side lip and is provided in a diametrically outermost position in such a manner as to project axially inwards, is brought into sliding contact with an entire circumference of an axial side surface of the diametrically inside circular ring portion 21 which makes up the slinger 16. On the contrary, distal edges of the remaining two intermediate and inside seal lips 23, 24 are brought into sliding contact with an outer circumferential surface of the diametrically inside cylindrical portion 20 which makes up the slinger 16.

On the other hand, the seal ring 14b which closes an outer end opening of the interior space 13 is, as is shown in FIG. 20, made up of a core metal 25 and a seal member 26. This seal member 26 is made of an elastic material such as an elastomer like a rubber, includes three, outer, intermediate and inside seal lips 27 to 29 and is fixedly connected to the core metal 25 at a proximal end portion thereof. Then, a distal edge of the outside seal lip 27, which is referred to as a side lip and is provided in a diametrically outermost position in such amanner as to project axially outwards, is brought into sliding contact with an entire circumference of an inner surface of a proximal end portion of the mounting flange 9, and distal edges of the remaining two intermediate and inside seal lips 28, 29 are brought into sliding contact with an entire circumference of a portion where the inner surface of the proximal end portion continues to the outer circumferential surface of the intermediate portion of the hub main body 4 and the outer circumferential surface of the intermediate portion, respectively.

By closing both the end openings of the interior space 13 by the seal rings 14a, 14b which are configured as has been described above, the intrusion of foreign matters such as mud and water into the interior space 13 is prevented and the leakage of grease sealed in inside of the interior space 13 therefrom to the outside is prevented. Note that in the case of the related-art construction, among the respective sets of seal lips 22 to 24, 27 to 29, the outside seal lips 22, 27, which are located diametrically outermost and hence closest to the exterior space to thereby be exposed to the mud and water, are conventionally formed to be uniform in thickness from their distal end portions to distal positions.

In order to increase the sealing properties by the seal rings 14a, 14b which are configured as has been described above, a proper sliding contact state needs to result between the distal edges of the respective seal lips 22 to 24, 27 to 29 which make up the seal rings 14a, 14b, respectively, and their mating surfaces. In this respect, the sliding contact state between the diametrically outside seal lips 22, 27, which lie in the diametrically outermost positions in those seal lips 22 to 24, 27 to 29 which make up the seal rings 14a, 14b, respectively, and their mating surfaces tends to easily become inappropriate due to assembling error or elastic deformation of the respective portions that is caused while the vehicle is running.

An instance of a drawback like that will be described by taking as an example the seal ring 14a shown in FIG. 19 which is adapted to close the inner end opening of the interior space 13. Firstly, there exists a possibility that the sliding contact state between the distal edge of the diametrically outside seal lip 22 and the axial side surface of the diametrically inside circular ring portion 21 of the slinger 16 fails due to an axial positional deviation between the core metal 16 and the slinger 16. Namely, when building the seal ring 14a in the inner end opening of the interior space 13, there is caused a possibility that the axial relative positions of the core metal 15 and the slinger 16 are caused to deviate from their proper positions to some extent due to assembling error. Then, in the event that such a deviation actually occurs, a distance between the diametrically outside circular ring portion 19 of the core metal 15 and the diametrically inside circular ring portion 21 of the slinger 16 is caused to deviate from a designed value. For example, in the event that the distance is decreased to become smaller than the designed value, the interference (an elastic deformation amount) of the outside seal lip 22 becomes larger than a designed value, and a contact force at a sliding contact portion between the distal edge of the outside seal lip 22 and the axial side surface of the diametrically inside circular ring portion 21 becomes larger than a designed value. As a result, a sliding resistance (seal torque) at the sliding contact portion is increased, and additionally, the outside seal lip 22 is caused to easily wear and yield, thereby making it difficult to secure the durability of the seal ring 14a.

On the contrary, in the event that the distance becomes larger than the designed value, the interference of the outside seal lip 22 becomes smaller than the designed value, the contact force at the sliding contact portion between the distal edge of the outside seal lip 22 and the axial side surface of the diametrically inside circular ring portion 21 becomes lower than the designed value. As a result, the sealing performance by the outside seal lip 22 is decreased, thereby making it difficult to realize an effective prevention of the intrusion of foreign matters into the interior space 13.

In addition, the sliding contact state between the distal edges of the outside seal lips 22, 27 and their mating surfaces is also made to become improper due to respective constituent members of the rolling bearing unit being elastically deformed while the vehicle is running. Namely, the sliding contact state between the distal edges of the outside seal lips 22, 27 and their mating surfaces becomes uneven with respect to a circumferential direction due to the respective constituent members of the rolling bearing being elastically deformed by a moment applied from a ground contact surface or a tread of a tire which makes up the road wheel to the hub 2 via the mounting flange 9, and this also causes the problem of the reduced durability and sealing performance of the outside seal lips 22, 27. An instance of a drawback like this will be described based on FIGS. 21 to 22 by taking as an example the seal ring 14a on the inner end opening side of the interior space 13.

A case will be described in which a moment M generated in association with a turning of the vehicle is applied in a clockwise direction in FIG. 21 as is indicated by an arrow therein. In this case, a center axis of the hub 2 is displaced by an extent equal to an angle θ from a position a indicating a neutral state to a position β by elastic deformations of the respective constituent members of the rolling bearing unit. As a result, the diametrically inside circular ring portion 21 of the slinger 16 which is fixedly fixed on the inner end portion of the inner ring element 5 which makes up the hub 2 is also inclined substantially by the extent equal to the angle θ. In the case of the state shown in FIG. 21, the diametrically inside circular ring portion 21 is displaced in a direction in which it moves away from the core metal 15 as is shown in FIG. 22A at an upper portion of the same figure. As a result, the interference of the outside seal lip 22 is decreased at the upper portion of the figure, while in a lower portion of FIG. 21, as is shown in FIG. 22B, the diametrically inside circular ring portion 21 is displaced in a direction in which it moves towards the core metal 15. As a result, the interference of the outside seal lip 22 is increased at the lower portion of the figure. On the other hand, as to the seal ring 14b which closes the outer end opening of the interior space 13, the seal ring 14b moves in an opposite manner as to the inner end seal ring 14a. In either of the cases, in these seal rings 14a, 14b, the foreign matter intrusion preventive action of the respective outside seal lips 22, 27 is lost at those portions where the interferences of the outside seal lips 22, 27 are decreased.

To cope with this, in the related art, the interferences of the respective outside seal lips 22, 27 are set so as to secure the sealing properties at the relevant portions even in the event that the interferences of the outside seal lips 22, 27 are partially decreased in association with the inclination of the center axis of the hub 2 based on the moment M. To be specific, the interferences of the respective outside seal lips 22, 27 which result when the center axis is not inclined are set larger, so that the interferences of the respective outside seal lips 22, 27 can remain effective enough to secure the sealing properties around the full circumference thereof even in the event that the center axis is inclined. Where the interferences are set larger in the way described above, however, to compensate for the increased interferences, the sliding resistance with respect to the outside seal lips 22, 27 is increased, and additionally, these outside seal lips 22, 27 are made to easily wear and yield. The increase in sliding resistance results in an increase in rotational resistance, leading to deterioration of the running performance mainly in the areas of fuel economy and acceleration, which is not preferable. In addition, the easy wear and yield of the seal lips results in reduction in durability of the rolling bearing, which is not preferable, either.

In view of these situations, Patent Document Nos. 1, 2 describe constructions in which in order to make it difficult for a change in the interference of an outside seal lip to trigger a change in pressure at a sliding contact portion, a constricted portion where the thickness is decreased is provided at a proximal end portion of the outside seal lip. According to the construction like this, a change in contact pressure between a distal edge of the outside seal lip and its mating surface becomes less sensitive to a change in interference of the outside seal lip attributed to assembling error or the inclination of the center axis of a hub when the vehicle is turning. In other words, even in the event that the interference changes, the contact pressure changes little. Because of this, even when the interference is set larger, the sliding resistance of the outside seal lip is suppressed, and in addition to this, the wear of the outside seal lip can also be suppressed.

Furthermore, in recent years, there exists a tendency to pay more attention to fuel economy and acceleration as the performance of the vehicle, and hence seal rings need to satisfy severer requirements associated therewith. Because of this, even when the interference of a seal lip is increased to secure a long-term sealing performance (a durability performance) thereof, it is required that the sliding resistance of the seal lip is suppressed to a lower level. In the case of the constructions described in Patent Document Nos. 1, 2, however, only the reduction in thickness at the proximal end portion of the outside seal lip is taken into consideration, and no consideration is taken as to the shape of other portions of the outside seal lip such as a portion lying closer to a distal end thereof. Because of this, in the event that the interference of the outside seal lip is increased or a change in the interference becomes large, there may be caused a possibility that a change in area where the distal edge of the outside seal lip contacts its mating surface, a change in position where the outside seal lip contacts its mating surface and a change in pressure distribution at the contact portion cannot be suppressed sufficiently.

An instance of the drawback like this will be described by taking as an example a change in seal contact portion which is triggered when the interference is increased by reference to FIGS. 23 to 24 which are enlarged views of a portion E of the seal device shown in FIG. 19. As is shown in FIGS. 23 to 24, when the interference of the outside seal lip 22 relative to the slinger 16 is increased, the elastic deformation amount of the outside seal lip 22 is increased, and the contact area between the distal edge of the outside seal lip 22 and the axial side surface of the diametrically inside circular ring portion 21 is increased. As this occurs, the sliding resistance is increased, constituting a cause for an increase in torque. In addition, a portion of the outside seal lip 22 which lies further diametrically inwards (proximally) than the distal edge P of thereof is made easy to be brought into strong contact with the axial side surface, and as this tendency becomes remarkable, as is shown in FIG. 24 in an exaggerated fashion, a portion of the outside seal lip 22 which lies slightly further diametrically inwards (proximally) than a distal end thereof is brought into the axial side surface of the diametrically inside circular ring portion 21, whereby the distal edge P is caused to move apart from the axial side surface, resulting in a possibility that a so-called floating state is produced. When this floating state is produced, the peak of surface pressure is not allowed to be applied to the distal edge P of the outside seal lip 22, resulting in a risk that the intrusion of foreign matters through a gap between the distal edge P and the axial side surface of the diametrically inside circular ring portion 21 is facilitated. In particular, in the case of the seal device which is conventionally known, an angle β (refer to FIG. 15, which will be described later on) formed between the inner circumferential surface (the internal surface) of the outside seal lip 22 and the axial side surface of the diametrically inside circular ring portion 21 which makes up the slinger 16 was 10 degrees or a smaller value than that in such a state that the seal ring 14a and the slinger 16 are assembled. Because of this, even when the axial distance between the core metal 15 and the slinger 16 is reduced to be slightly smaller than the designed value, the distal edge P of the outside seal lip 22 is made to easily float as is shown in FIG. 24.

In the case of the constructions described in Patent Document Nos. 1, 2, since only the reduction in thickness of the proximal end portion of the outside seal lip is taken into consideration, in the event that the interference of the outside seal lip is increased, although an increase in contact pressure with its mating surface can be suppressed to some extent, it cannot be said that the elastic deformation at the distal end portion can be suppressed sufficiently. Because of this, as with the case shown in FIGS. 23 to 24, the shape of the distal end portion of the outside seal lip is deformed, resulting in a possibility of an increase in contact area between the distal edge of the outside seal lip and its mating surface, a change in contact position between the outside seal lip and its mating surface and a large change in pressure distribution at the relevant contact portions. In addition, in the case of the constructions described Patent Document Nos. 1, 2, since no consideration is taken as to wear that is produced on its mating surface, there still exists a room for improving highly the compatibility of two contradicting performances of reducing the frictional resistance of the outside seal lip and increasing the durability thereof.

While the drawbacks that have been described heretofore become remarkable with the respective outside seal lips 22, 27 whose distal edges are brought into sliding contact with their mating surfaces in such a state that the distal edges and their mating surfaces are pressed against each other in the axial direction, they may also be able to occur with the respective intermediate and inside seal lips 23, 24 (refer to FIG. 19) and the inside seal lip 29 (refer to FIG. 20) whose distal edges are brought into sliding contact with their mating surfaces in such a state that the distal edges and their mating surfaces are pressed against each other in a radial direction. Namely, the respective distal edges of these seal lips 23, 24, 29 are brought into sliding contact with the outer circumferential surface of the diametrically inside cylindrical portion 20 of the slinger 16 or the outer circumferential surface of the intermediate portion of the hub main body 4 which are their mating surfaces lying or oriented in the radial direction. Because of this, in the event that a change in interference of the respective seal lips 23, 24, 29 is increased due to assembling error or the like or the sliding contact portions wear, there is caused a possibility that the respective distal edges of these seal lips 23, 24, 29 are made to float relative to their mating surfaces.

In addition, there exists Non-Patent Document No. 1 as a publication related to the invention.

[Patent Document No. 1] Japanese Utility Model Unexamined Publication JP-A-5-73364

[Patent Document No. 2] Japanese Utility Model Unexamined Publication JP-A-5-73365

[Non-Patent Document No. 1] “Sealing Mechanism for Oil Seal” pages 38 to 47, No. 2 of Vol. 62 written by Kenpachi Nakamura and issued in February, 1989 as a Japan Rubber Association journal by Japan Rubber Association

### SUMMARY OF THE INVENTION

In view of these situations, the invention was made to prevent the floating of the edge of the seal lip relative to its mating surface even when there occurs a large change in the interference of the seal lip due to assembling error or the like so as to make the two contradicting performances of reducing the torque and increasing the durability highly compatible with each other without reducing the sealing performance even when the seal lip and its mating surface wear.

Namely, the invention was made to realize a construction which can make the magnitude of contact force at the sliding contact portion between the edge of the seal lip and its mating surface difficult to be affected by assembling error or the inclination of the center axis of the hub based on the moment load and furthermore can prevent the floating of the edge of the seal lip so as to secure the sealing properties sufficiently even when the interference of the seal lip is increased or the sliding contact portion wears.

According to a first aspect of the invention, there is provided

1. A seal device made of an elastic material for sealing off an interior space defined between primary and secondary members which are adapted to rotate relatively to each other from an exterior space which is defined outside of the interior space, the seal device comprising:

an annular seal lip which is supported on the primary member, wherein

a edge of the seal lip is brought into sliding contact with an entire circumference of a contact surface of the secondary member or a tertiary member which is fixed to the secondary member, and

an angle formed between the edge of the seal lip and the contact surface of the secondary member or the tertiary member on the interior space's side is in the range of 13 to 45 degrees.

In addition, according to a second aspect of the invention, there may be provided a seal device as set forth in the first aspect of the invention, the contact surface of the secondary member or the tertiary member, with which the edge of the seal lip is brought into sliding contact, intersects a rotational center axis of the primary and secondary members at right angles.

According to a third aspect of the invention, there may be provided a seal device as set forth in the second aspect of the invention, further comprising:

a core metal which is fixedly fitted in a circumferential surface of the primary member, wherein

a proximal end portion of the seal lip is fixedly connected to the core metal, and wherein

the seal lip is formed to have in its free state an overall shape which flares in such a way that its diameter increases from the proximal end portion towards a distal end portion thereof, with a sectional shape of the seal lip along a plane containing the rotational center axis in its free state being such that;

a bending point exists at an intermediate portion of an inner circumferential surface of the seal lip; and

an angle of inclination of the inner circumferential surface relative to the center axis at a point lying further distally than the bending point is made smaller than an angle of inclination of the inner circumferential surface relative to the center axis at a point lying further proximally than the bending point.

According to a fourth aspect of the invention, there may be provided a seal device as set forth in the first aspect of the invention, a minimum thickness portion which is the smallest in thickness lies in a vicinity of the proximal end portion of the seal lip.

According to a fifth aspect of the invention, there may be provided a seal device as set forth in the first aspect of the invention, further comprising a core metal which is fixedly fitted in a circumferential surface of the primary member, wherein

a distal end portion of the seal lip is fixedly connected to the core metal,

the seal lip is formed to have in its free state an overall shape which flares in such a way that its diameter increases from the proximal end portion towards a distal end portion thereof, with a sectional shape of the seal lip along a plane containing the rotational center axis in its free state being such that;

a bending point exists at an intermediate portion of an inner circumferential surface of the seal lip; and

an angle of inclination of the inner circumferential surface relative to the center axis at a point lying further distally than the bending point is made smaller than an angle of inclination of the inner circumferential surface relative to the center axis at a point lying further proximally than the bending point, and

a minimum thickness portion which is the smallest in thickness lies in a vicinity of the proximal end portion of the seal lip.

According to a sixth aspect of the invention, there may be provided a seal device as set forth in the first aspect of the invention,

the thickness of the distal end portion of the seal lip is larger than the thickness thereof from an intermediate portion to the proximal end portion, and

a sectional shape of a portion of the edge of the seal lip which is brought into contact with the contact surface of the secondary member or the tertiary member along an imaginary plane containing the rotational center axis of the primary and secondary members is such that an angle of the portion of the distal edge is made into an acute angle.

According to a seventh aspect of the invention, there is provided a rolling bearing unit with a seal device comprising:

an outer ring corresponding member comprising an outer ring raceway on an inner circumferential surface thereof;

an inner ring corresponding member comprising an inner ring raceway on an outer circumferential surface thereof;

a plurality of rolling elements which are rotatably provided between the outer ring raceway and the inner ring raceway; and

a seal device for closing an end opening of a space existing between the inner circumferential surface of the outer ring corresponding member and the outer circumferential surface of the inner ring corresponding member, wherein

the seal device is made up of a seal device as set forth in the first aspect of the invention.

With the seal device and the rolling unit with a seal device of the invention which are configured as has been described above, since the angle formed between the edge of the seal lip and the contact surface of the other member or the member fixed to the other member on the interior space's side is restricted to be in the range of 13 to 45 degrees, the contact force at the sliding contact portion between the edge of the seal lip and the other member can be made appropriate irrespective of assembling error or relative displacement of the respective constituent members of the rolling bearing unit. In addition, the intrusion of foreign matters into the interior space through the sliding contact portion is prevented effectively, and the reduction in friction (torque) that is generated by the seal lip and increase in durability of the seal lip can be realized. Because of this, for example, when the seal device is applied to a rolling bearing unit with a seal device for supporting a road wheel of a vehicle, the running performance of the vehicle mainly in the areas of fuel economy and acceleration can be increased at the same time that the durability of the rolling bearing unit with a seal device can be increased.

The reason the angle formed between the edge of the seal lip and its mating member on the interior space's side is restricted to be in the range of 13 to 45 degrees is as follows. Firstly, when this angle is less than 13 degrees, in the event that the interference of the edge of the seal lip relative to the surface of the other member is increased due to on assembling error or the relative displacement of the constituent members that is generated while the vehicle is being driven, as is shown in FIGS. 23, 24, the contact area between the edge of the seal lip and the surface of its mating member is increased to thereby increase the sliding resistance, and the dynamic torque of the rolling bearing unit becomes easy to be increased. When the angle is held to be 13 degrees or more, even though the interference is increased, the increase in contact area is limited, whereby the increase in sliding resistance is suppressed to thereby suppress the increase in dynamic torque of the rolling bearing unit.

On the contrary to this, when the angle is increased to exceed 45 degrees, it becomes disadvantageous from the viewpoint of securing the sealing properties with the interference being an appropriate value. Namely, the sealing properties of the seal portion made up by bringing the edge of the seal lip into sliding contact with its mating surface is affected by the magnitude of the angle formed by the distal edge and the mating surface. To be specific, as is shown in FIG. 17, with a distal edge of a seal lip 30 in sliding contact with its mating surface 31 and an angle (a contact angle) formed between the surface of a distal edge portion of the seal lip 30 and its mating surface 31 being α on the side of an exterior space 32 and β on the side of an interior space 33 (=the angle formed at the sliding contact portion between the edge of the seal lip and the other member on the interior space's side), it is conventionally known from the description in Non-Patent Document No. 1 and the like that it is advantageous that α>β in securing the sealing properties. Since the mating surface 31 is a flat plane (the angle is 180 degrees) and an angle γ at a distal end portion of the seal lip 30 is generally in the range of 80 to 100 degrees, α+β becomes on the order of 100 to 80 degrees. Consequently, in order to achieve α−β≧10 degrees to ensure α>β, β needs to be at least β≧45 degrees (with γ=80 degrees) and preferably β≦35 degrees (with γ=100 degrees).

In the case of the invention, the angle formed at the sliding contact portion between the edge of the seal lip and the other member on the side of the interior space is restricted to be in the range of 13 to 45 degrees (preferably 13 to 35 degrees) from the reason described above.

The function and advantage of the invention that is configured as has been described above can be obtained on anywhere on the surface of the member with which the edge of the seal lip is brought into sliding contact. In particular, the function and advantage can specifically be obtained when the surface of the member with which the edge of the seal lip is brought into sliding contact is a plane which exists in a direction at right angles to the rotational center as is described in the second aspect of the invention. Namely, in the seal device having the plane like that and in which the edge of the seal lip faces the surface of the other member or the member fixed to the other member in the axial direction, the distance between the one member and the other member is easy to be deviated from the optimal value due to assembling error or elastic deformations of the constituent members that occur while the vehicle is in operation. Consequently, when attempting to increase the durability of the rolling bearing unit with a seal device and at the same time the running performance of the vehicle mainly in the areas of fuel economy and acceleration.

In addition, when carrying out the invention, as is described in the third aspect of the invention, in the event that the bending point is provided at the intermediate portion of the inner circumferential surface of the seal lip and that the angle of inclination of the inner circumferential surface relative to the center axis at the point lying further distally than the bending point is made smaller than the angle of inclination of the inner circumferential surface relative to the center axis at the point lying further proximally than the bending point, a value of 13 degrees or more can be secured as the angle formed at the sliding contact portion on the side of the interior space without enlarging the size of the seal device. Namely, in order to improve the following properties of the seal lip to the surface of the mating member, a certain lengthwise dimension needs to be secured from the proximal end portion to distal end portion of the seal lip. Then, when attempting to secure the value of 13 degrees or more while securing the certain lengthwise dimension, in the event that the sectional shape of the inner circumferential surface of the seal lip is linear, the axial length from the proximal end portion to the distal end portion becomes long, and hence, the miniaturization of the seal device (reduction of the axial length) cannot be realized. On the contrary to this, in the event that the bending point is provided, the reduction of the axial length of the seal lip can be realized while securing the required lengthwise dimension thereof and the value of 13 degrees or more can also be secured.

In addition, as is described in the fourth aspect of the invention, in the event that the minimum thickness portion is made to lie in the vicinity of the proximal end portion of the seal lip, the following properties of the portion of the seal lip which extends from the intermediate portion to the distal end portion thereof to the surface of the other member or the member fixed to the other member can be improved. Then, the surface pressure at the sliding contact portion between the surface and the edge of the seal lip is prevented from being reduced at part of the circumferential direction, so as to improve the sealing properties of the sliding contact portion. In particular, in the event that the portion in the vicinity of the proximal end portion where the minimum thickness portion is provided is formed to have the circular arc-like shape and that the thickness of the seal lip is gradually increased from the minimum thickness portion towards the distal edge thereof, the deformation of the seal lip can be limited to a portion other than the distal end portion such as the proximal end portion to some extent. Then, the effect imposed on the contact force at the sliding contact portion between the edge of the seal lip and its mating surface by the change in the interference of the seal lip can be decreased.

In particular, in the event that the thickness of the seal lip is gradually increased from the proximal end portion towards the distal end portion, the deformation of the seal lip can be concentrated further, thereby making it possible to decrease the effect imposed on the contact force at the sliding contact portion by the change in interference. Because of this, irrespective of a change in interference, the occurrence of a great change in contact shape and contact load of the distal end portion of the seal lip can be prevented more effectively. In addition, since the seal lip is made easy to be deformed at other portions than the distal end portion, the concentration of excessive tensile stress at part of the inner circumferential surface of the distal end portion is eliminated, thereby making it possible to suppress the yield (permanent deformation) of the seal lip to a minimum level. Consequently, the reduction in contact load due to the yield can be suppressed to a minimum level, thereby making it possible to decrease further an initial contact pressure between the edge of the seal lip and the mating surface. Furthermore, even in case the region of the distal edge gets worn slightly, the thickness dimension of the region of the distal edge can be held to a required amount, and hence, a required rigidity for the region of the distal edge can be secured, so as to secure the required sealing properties.

Furthermore, as is described in the fifth aspect of the invention, in the event that the thickness dimension of the distal end portion of the seal lip is made large and that the edge of the seal lip is pointed, the sliding contact state between the seal lip and the surface (mating surface) of the other member or the member fixed to the other member is stabilized further. Namely, in the event that the thickness dimension of the distal end portion of the seal lip is increased and that a diametrical expansion force (a force required to expand the diameter) of the distal end portion is increased, the deformation of the distal end portion can be suppressed and the deformation can be concentrated on the portion of the seal lip which extends from the proximal end portion to the intermediate portion in such a state that the edge of the seal lip is pressed against the mating surface. Because of this, the sliding contact state between the edge of the seal lip and the mating surface can be stabilized. In addition, in the event that the edge of the seal lip is pointed, the angle formed at the sliding contact portion on the side of the interior space becomes easy to be secured, whereby it becomes easy to make the securing of the sealing properties and the suppression of the sliding resistance highly compatible with each other.

### BRIEF DESCRIPTION OF THE DRAWINGS

FIG. 1 is a drawing corresponding to an enlarged sectional view of a portion A in FIG. 18 and shows a first embodiment of the invention;

FIG. 2 is a drawing which shows only a core metal and a seal member which are taken out from FIG. 1;

FIG. 3A is a drawing corresponding to a portion B in FIG. 2 and shows a deformed state of an outside seal lip of the first embodiment in a free state thereof;

FIG. 3B is an enlarged sectional view corresponding to the portion B in FIG. 2 and shows a deformed state of the outside seal lip of the first embodiment in such a state that a slinger is brought into contact with the outside seal lip with an interference provided thereto.

FIG. 4A is a drawing corresponding to a portion C in FIG. 19 and shows a deformed state of a related-art outside seal lip in a free state thereof;

FIG. 4B is an enlarged sectional view corresponding to the portion C in FIG. 19 and shows a deformed state of the related-art outside seal lip in such a state that a slinger is brought into contact with the outside seal lip with an interference provided thereto;

FIG. 5 is a similar drawing to FIG. 1 and shows a second embodiment of the invention;

FIG. 6 is a drawing which shows only a core metal and a seal member which are taken out from FIG. 5;

FIG. 7 is a similar drawing to FIG. 1 and shows a third embodiment of the invention;

FIG. 8 is a drawing which shows only a core metal and a seal member which are taken out from FIG. 7;

FIG. 9 is a drawing which shows deformed states of respective seal lips which result in association with the assemblage of the slinger;

FIG. 10 is a similar drawing to FIG. 1 and shows a fourth embodiment of the invention;

FIG. 11 is a drawing which shows only a core metal and a seal member which are taken out from FIG. 10;

FIG. 12 is a similar drawing to FIG. 1 and shows a fifth embodiment of the invention;

FIG. 13 is a similar drawing to FIG. 2 and shows a sixth embodiment of the invention;

FIG. 14 is a drawing corresponding to an enlarged sectional view of a portion D in FIG. 18 and shows a seventh embodiment of the invention;

FIG. 15A is a sectional view of a seal device according to the embodiment of the invention;

FIG. 15B is a sectional view of a seal device according to a comparison example of the invention;

FIG. 16 is a diagram which shows the results of an experiment carried out on the seal device of the embodiment and the seal device of the comparison example of the invention;

FIG. 17 is an exemplary drawing which explains an effect imposed on sealing properties by an angle formed by a edge of the seal lip and its mating surface;

FIG. 18 is a sectional view of a rolling bearing unit with seal rings which shows an example of a related-art construction;

FIG. 19 is an enlarged sectional view of a seal ring which is built in the portion A in FIG. 18.

FIG. 20 is an enlarged sectional view of a seal ring which is built in the portion D in FIG. 18.

FIG. 21 is a sectional view of the rolling bearing unit with seal rings which shows a state in which a hub is inclined by a moment load applied when a vehicle is running;

FIG. 22A is a partially enlarged sectional view which shows a displaced state of a slinger of the seal ring built in the rolling bearing unit with seal rings shown in FIG. 21;

FIG. 22B is a partially enlarged sectional view which shows a displaced state of the slinger of the seal ring built in the rolling bearing unit with seal rings shown in FIG. 21;

FIG. 23 is an enlarged sectional view of a portion E in FIG. 19 and shows a contact state of an outside seal lip which results when interference is increased in the related-art construction; and

FIG. 24 is a drawing similar to FIG. 23 and shows a state in which a distal end of the outside seal lip floats from a side surface of the slinger when the interference is increased further.

### DETAILED DESCRIPTION OF EXEMPLARY EMBODIMENTS OF THE INVENTION EMBODIMENTS

### First Embodiment

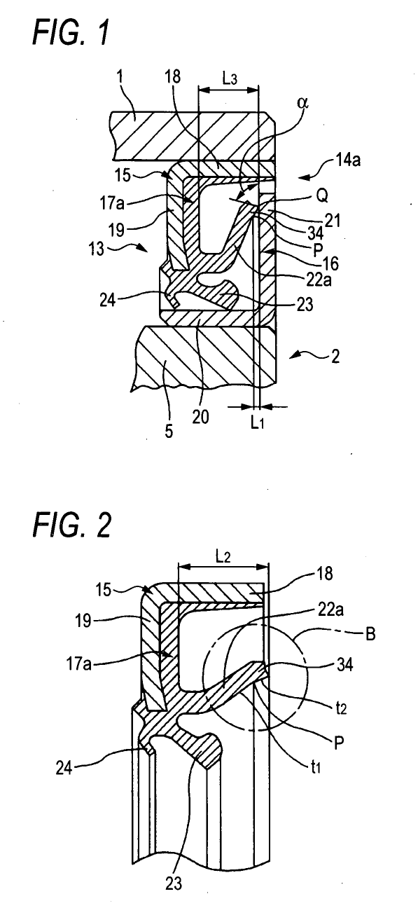

FIGS. 1 to 3 shows a first embodiment of the invention which corresponds to the first to third and seventh aspects of the invention. A seal ring 14a which makes up a seal device of this embodiment is such that a seal material 17a supported on a core metal 15 is combined with a slinger 16 so as to make up a seal ring and is mounted between an outer ring 1 (an outer ring corresponding member) and a hub 2 (an inner ring corresponding member) which constitute a pair of members adapted to rotate relatively to each other. Then, the seal ring 14a so configured seals off an interior space 13 which exists between an inner circumferential surface of the outer ring 1 and an outer circumferential surface of the hub 2 from an exterior space. To make this happen, the seal ring 14a includes the core metal 15 which fixedly fits in an inner end portion of the outer ring 1 and the seal material 17a made of an elastic material such as an elastomer like a rubber which is connected to the core metal 15. In addition, this seal material 17a includes a plurality of (three in the case of the embodiment shown in the figures) outside, intermediate and inside seal lips 22a, 23, 24. Among these seal lips, distal edges of the outside and intermediate seal lips 22a, 23 are brought into sliding contact with a metal slinger 16 which fixedly fits on an outer circumferential surface of an inner end portion of an inner ring element 5 which makes up the hub 2. In addition, a distal edge of the inside seal lip 24 is made to face closely an outer circumferential surface of a diametrically inside cylindrical portion 20 of the slinger 16.

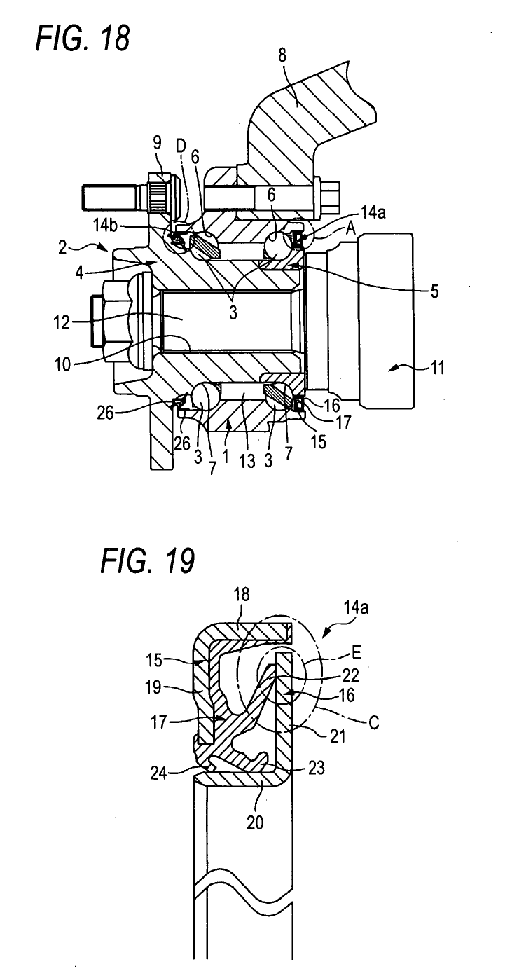

Note that the feature of this embodiment resides in a point that among the plurality of seal lips 22a, 23, 24, the shape of the outside seal lip 22a, which lies in a diametrically outermost position and which is referred to as a side lip, is devised to increase the sealing performance by this outside seal lip 22a and the durability of the outside seal lip 22a and to reduce the sliding resistance (dynamic torque). Since the configurations and functions of the other portions are similar to the aforesaid related-art construction shown in FIGS. 18 to 20, like reference numerals will be given to like portions to those of the related-art construction, so that the repetition of a similar description will be omitted or the like portions will be described briefly, and a characteristic part of this embodiment will mainly be described below.

In the case of this embodiment, the distal edge of the outside seal lip 22a is brought into sliding contact with an entire circumference of an axial side surface of a diametrically inside circular ring portion 21 of the slinger 16 which exists to the side of the outside seal lip 22a. In addition, the thickness of the outside seal lip 22a is made substantially constant along the full length from a proximal end portion to a distal end portion thereof, and an overall shape of the outside seal lip 22a in its free state is made to flare in such a manner that the diameter increases as it extends from the proximal end portion to the distal end portion. In addition, a bent portion 34 is provided at a portion of an intermediate portion of the outside seal lip 22a which lies closer to a distal end thereof in such a manner as to be bent towards the diametrically inside circular ring portion 21 which makes up the slinger 16. Consequently, a bending point P exists at a portion of an intermediate portion which lies closer to a distal end of a sectional shape with respect to an imaginary plane containing a rotational center axis of the hub 2 (or taken along this imaginary plane) of an inner circumferential surface of the outside seal lip 22a in its free state.

Namely, the sectional shape of the inner circumferential surface in the free state is such as to be produced when a straight line which touches the intermediate portion (a tangent with respect to a representative position of the intermediate portion) t₁ and a straight line which touches the distal end portion of the outside seal lip 22a (a tangent with respect to a representative position of the distal end portion) t₂ intersect each other at the bending point P. In addition, of angles of inclination θ₁, θ₂ of these straight lines t₁, t₂ relative to the center axis, the angle of inclination θ₂ of the straight line t₂ which lies further distally than the bending point P is made smaller than the angle of inclination θ₁ of the straight lint t₁ which lies further proximally than the bending point P (θ₂<θ₁). In other words, an angle of inclination of the inner circumferential surface of the outside seal lip 22a relative to the axial side surface of the diametrically inside circular ring portion 21 is made larger at the portion lying further distally than the bending point P than at the portion lying further proximally than the bending point P.

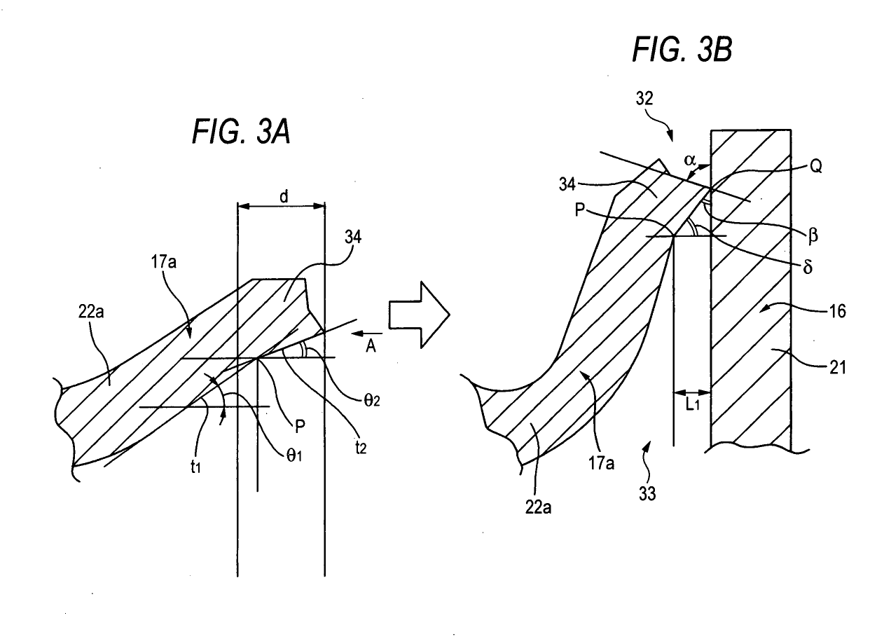

Then, as is shown in FIGS. 1 and 3B, the outside seal lip 22a is brought into contact with the axial side surface of the diametrically inside circular ring portion 21 of the slinger 16 in a contact position Q with an interference d (refer to FIG. 3A) provided thereto. The dimensions and shapes of the respective constituent members are regulated in such a manner that an angle formed by a surface of a distal edge portion of the outside seal lip 22a and the side surface of the diametrically inside circular ring portion 21 satisfies the following conditions. Namely, let the contact angle be α on a side facing an exterior space 32 and be β on a side facing an interior space 33, α>β. In addition, of these angles, the contact angle β on the side facing the interior space 33 is made to be in the range of 13 to 45 degrees. Note that when letting an axial length of the outside seal lip 22a in its free state be L₂ (refer to FIG. 2) and an axial length of the outside seal lip 22a in an assembled state be L₃ (refer to FIG. 1), the interference d is a magnitude which is expressed by L₂−L₃. The interference d is also regulated in relation to the dimension and shape of the outside seal lip 22a so as to satisfy the conditions, α>β and β=13 to 45 degrees.

As is described above, in the case of this embodiment, the contact angle β formed at the sliding contact portion between the distal edge of the outside seal lip 22a and the axial side surface of the diametrically inside circular ring portion 21 of the slinger 16 on the side of the interior space 33 is restricted to be in the range of 13 to 45 degrees. Because of this, irrespective of assembling error or a relative displacement between the core metal 15 and the slinger 16 which occurs while the vehicle is being driven, the contact force at the sliding contact portion between the distal edge of the outside seal lip 22a and the axial side surface of the diametrically inside circular ring portion 21 can be made proper. In addition, the intrusion of foreign matters into the interior space 33 through the sliding contact portion can be prevented and the reduction in friction (torque) and increase in durability of the rolling bearing unit with this seal device can be realized. Because of this, when the seal device is applied to, for example, a rolling bearing with a seal device for supporting a road wheel of a vehicle, the seal device can realize the increase in the durability of the rolling bearing unit with a seal device and at the same time increase in the running performance of the vehicle mainly in the areas of fuel economy and acceleration.

In addition, in the case of this embodiment, since the bent portion 34 is provided at the portion of the outside seal lip 22a which lies closer to the distal end of the intermediate portion thereof in such a manner as to be bent towards the diametrically inside circular ring portion 21 which makes up the slinger 16, a value of 13 degrees or more can be secured as the contact angle β formed at the sliding contact portion on the side of the interior space 33 without enlarging the size of the seal device. Namely, in order to improve the following properties of the distal edge of the outside seal lip 22a to the axial side surface of the diametrically inside circular ring portion 21 mating member, a certain lengthwise dimension needs to be secured from the proximal end portion to distal end portion of the outside seal lip 22a. In the event that this lengthwise dimension is too short, the rigidity of the outside seal lip 22a is increased while the elastic deformation amount thereof is decreased, the following properties being thereby deteriorated. Consequently, although the lengthwise dimension needs to be secured to some extent, in the event that the contact angle β is made to be 13 degrees or more with the sectional shape of the outside seal lip 22a in its free state kept in the straight-line shape, the axial length (a horizontal dimension in FIGS. 1 to 3) of the outside seal lip 22a from the proximal end portion to the distal end portion thereof becomes long, and the miniaturization (reduction in axial length) of the seal device cannot be realized. On the contrary to this, with the bent portion 34 provided, the reduction in the axial length can be realized while securing the length of the outside seal 22a, and the contact angle β can be made to be 13 degrees or more.

Moreover, since the bending point P is provided at the portion lying closer to the distal end of the inner circumferential surface of the outside seal lip 22a in such a manner as to correspond to the bent portion 34, even though the interference d of the seal ring 14a relative to the axial side surface of the diametrically inside circular ring portion 21 of the slinger 16 becomes slightly large, the value of 13 degrees or more can be secured as the contact angle β formed at the sliding contact portion on the side of the interior space 33, and at the same time, the distance L₁ (refer to FIG. 3B) between the bending point P and the contact position Q with respect to the axial direction can be secured sufficiently. In other words, the distal edge of the outside seal lip 22a is allowed to be brought into contact with the axial side surface of the diametrically inside circular ring portion 21 at an extremely narrow area, and portions other than the distal edge on the inner circumferential surface (the inner circumferential surface which corresponds to the straight line t₂) which lie in the vicinity of the distal edge of the outside seal lip 22a can be separated sufficiently from the axial side surface of the diametrically inside circular ring portion 21.

This will be described by reference to FIG. 3. Firstly, a case is considered in which the axial side surface of the diametrically inside circular ring portion 21 is pressed against the distal edge of the outside seal lip 22a as is indicated by an arrow A in FIG. 3A from the free state shown in FIG. 3A. As this occurs, although the outside seal lip 22a is deformed as a whole, since the angle of inclination θ₂ of the straight line t₂ which lies further distally than the bending point P relative to the center axis is small, as is shown in FIG. 3B, an opening angle δ at a portion lying closer to the distal end is suppressed to a small value compared to a case where the bending point P does not exist even in such a state that the portion of the outside seal lip 22a which lies closer to the distal end thereof is elastically deformed in a radially outward direction. Consequently, the contact angle β formed at the sliding contact portion on the side of the interior space 33, which is a complementary angle of this angle δ, can be secured to some extent (the angle becomes less than 13 degrees in no case). On the other hand, since the angle of inclination θ₁ of the straight lint t₁ which lies further proximally than the bending point P is made larger than the angle of inclination θ₂ of the straight line t₂ which lies further distally than the bending point P (θ₁>θ₂, and the proximal end side is easier to be deformed than the distal end side), an axial deformation amount becomes large at a portion of the outside seal lip 22a which lies closer to the proximal end thereof. Because of this, even when the interference d is increased, the contact angle β formed by the distal edge and the axial side face of the diametrically inside circular ring portion 21 can be secured sufficiently (13 degrees or more) while securing a required deformation amount with respect to the axial direction.

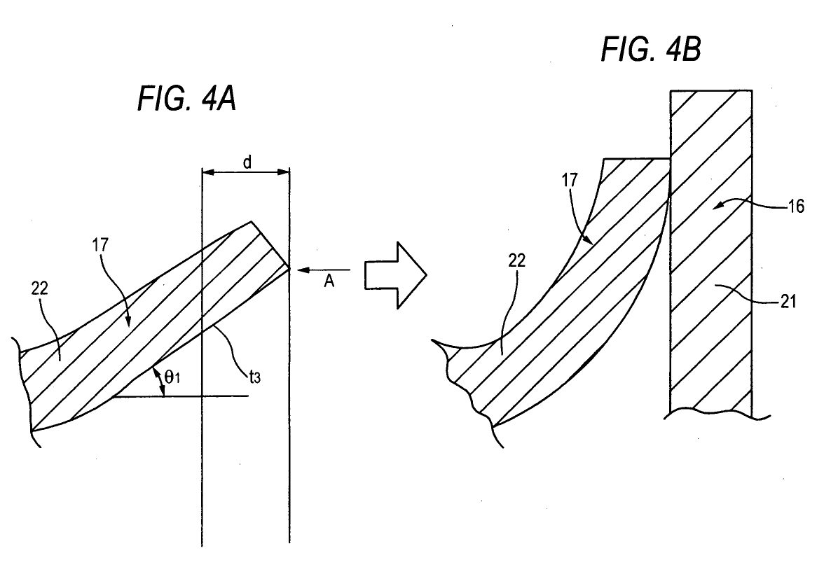

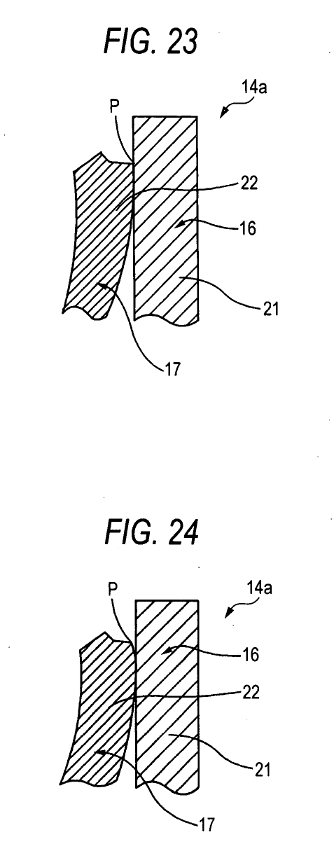

On the contrary to this, in the case of the aforesaid related-art construction shown in FIGS. 19, 23, 24, as is shown in FIG. 4A, the bending point (refer to FIGS. 1 to 3) does not exist on the inner circumferential surface of the outside seal lip 22, and the shape of a portion of the inner circumferential surface which lies closer to the distal end in its free state is formed into a partially conical cylindrical shape whose generating line is a straight line t₃. Because of this, in the event that an angle of inclination of the straight line t₃ relative to the center axis is made to be an angle of inclination θ₁ which is relatively large in order to secure a required deformation amount for the outside seal lip 22, when the axial side surface of the diametrically inside circular ring portion 21 of the slinger is pressed against the distal edge of the outside seal lip 22 in the axial direction as is shown in FIG. 4A, an opening angle of the portion of the outside seal lip 22 which lies closer to the distal end relative to the center line becomes substantially 90 degrees (the angle of the sliding contact portion formed on the side facing the interior space becomes substantially 0). Consequently, the portion of the outside seal lip 22 which lies closer to the distal end becomes easy to be brought into contact with the axial side surface of the diametrically inside circular ring portion 21 over a wide area.

In the case of this embodiment, being different from the related-art construction that is constructed as has been described above, even when the interference d becomes large, the contact angle β formed by the distal edge of the outside seal lip 22a and the axial side face of the diametrically inside circular ring portion 21 can be secured sufficiently (13 degrees or more), whereby the distal edge and the axial side surface of the diametrically inside circular ring portion 21 are brought into contact with each other at the extremely narrow area. In addition, the portions other than the distal edge on the inner circumferential surface which lie in the vicinity of the distal edge of the outside seal lip 22a can be separated sufficiently (to such an extent that an oil film which leads to an increase in sliding resistance is not formed) from the axial side surface of the diametrically inside circular ring portion 21. In other words, the contact area and contact width between the distal edge of the outside seal lip 22a and the axial side surface of the diametrically inside circular ring portion 21 can be suppressed to a low level.

According to the construction of the embodiment that has been described heretofore, even when a change in the interference d of the outside seal lip 22a becomes large, the effect imposed on a change in contact area and contact width by the change in the interference d can be suppressed to a low level, and a change in pressure distribution at the sliding contact portion can be suppressed to a low level. Because of this, even when the interference d becomes large due to assembling error or the inclination of the center axis of the hub 2 in association with the turning of the vehicle, or the sliding contact portion gets worn as when the diametrically inside circular ring portion 21 of the slinger 16 gets worn, the floating of the distal edge of the outside seal lip 22a can be prevented, so as realize an increase in sealing properties. Consequently, even when the initial interference of the outside seal lip 22a is set to a large value, the frictional resistance at the sliding contact portion can be reduced so as to realize the reduction in torque and increase in durability while securing the sealing properties sufficiently without increasing the contact width excessively in a neutral state (an initially set state).

In addition, in the case of this embodiment, since the thickness of the outside seal lip 22a is made substantially constant from the proximal end portion to the distal end portion, being different from the case where the thickness is gradually decreased from the proximal end portion towards the distal end portion, the deformation of the outside seal lip 22a can be concentrated on portions other than the distal end portion such as the proximal end portion to some extent, thereby making it possible to decrease the effect imposed on the contact force at the sliding contact portion between the distal edge of the outside seal lip 22a and the axial side surface of the diametrically inside circular ring portion 21 by the change in the interference d of the outside seal lip 22a. Because of this, irrespective of a change in the interference d, the occurrence of a great change in contact shape and contact load of the distal end portion of the outside seal lip 22a can be prevented more effectively. Furthermore, since the outside seal lip 22a is made easy to be deformed at the other portions than the distal end portion, the concentration of excessive tensile stress on part of the inner circumferential surface of the distal end portion is eliminated. Because of this, the yield (permanent deformation) of the outside seal lip 22a can be suppressed to a minimum level. Consequently, the reduction in contact load due to the yield can be suppressed to a minimum level, thereby making it possible to decrease further an initial contact pressure between the distal edge of the outside seal lip 22a and the axial side surface of the diametrically inside circular ring portion 21. As a result, according to the embodiment, the effect imposed on the contact force at the sliding contact portion between the distal edge of the outside seal lip 22a and the axial side surface of the diametrically inside circular ring portion 21 by the change in the interference d due to assembling error or the inclination of the center axis of the hub 2 because of moment load can be made small.

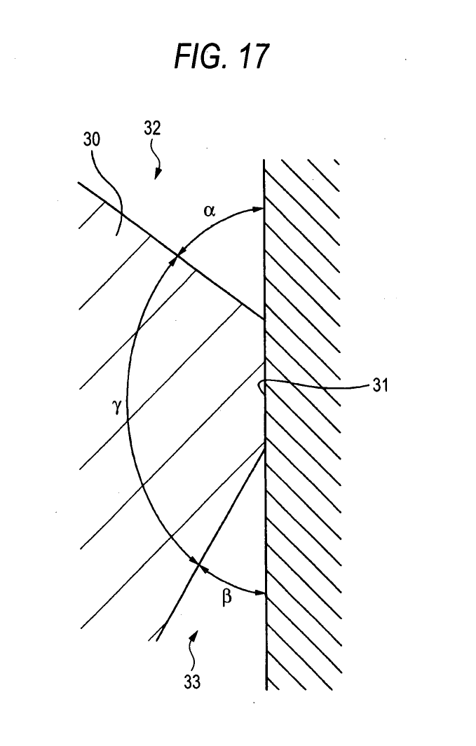

Note that in the event that the distal edge of the outside seal lip 22a is pressed against the axial side surface of the diametrically inside circular ring portion 21 by virtue of an elastic restoring force based on the interference d, it is preferable to secure a distance of 0.1 mm or longer even with a maximum interference for the distance L₁ between the bending point P and the contact position Q where the distal edge of the outside seal lip 22a and the axial side surface of the diametrically inside circular ring portion 21 are brought into contact with each other with respect to the axial direction. In the event that the distance L1 is shorter than 0.1 mm, in the event that a run-out is generated in the rolling bearing unit due to the amount of eccentricity, degree of inclination or the like while the vehicle is actually running, the inner circumferential surface of a diametrically inner portion (a portion lying closer to the proximal end portion) of the outside seal lip 22a is brought into contact with the axial side surface of the diametrically inside circular ring portion 21, whereby the contact width of the sliding contact portion is increased. Consequently, the length L₁ is more preferably made to be 0.3 mm or longer (in an initial state) in consideration of wear occurring on the axial side surface of the diametrically inside circular ring portion 21 and the distal edge of the outside seal lip 22a. In addition, although the angle γ (refer to FIG. 17) of the distal end portion of the outside seal lip 22a is made to be on the order of 80 to 100 degrees as with general seal lips, the angle formed by the surface of the distal edge portion of the outside seal lip 22a and the axial side surface of the diametrically inside circular ring portion 21 is restricted to the relationship described by reference to FIG. 17. Namely, the angle α on the side facing the exterior space 32 is made larger than the angle β on the side facing the interior space 33 (α>β), thereby making it possible to facilitate the securing of the sealing properties.

### Second Embodiment

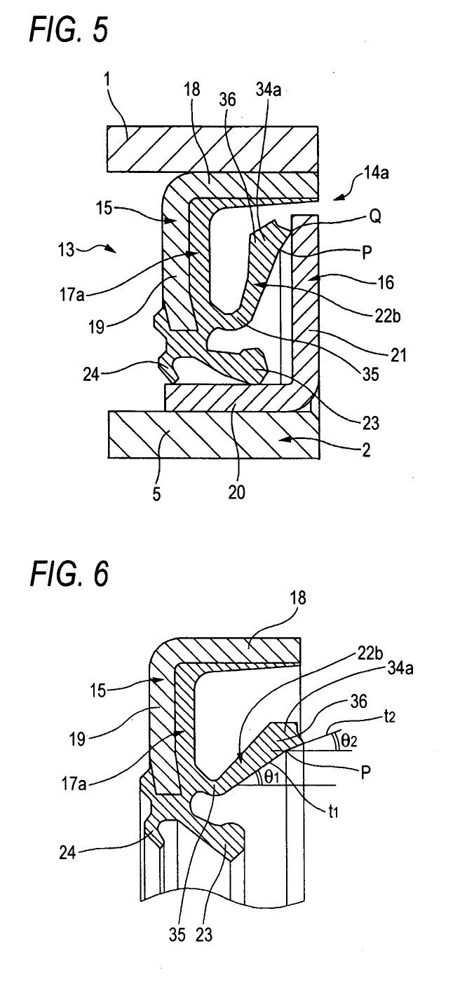

Next, FIGS. 5 to 6 shows a second embodiment of the invention which corresponds to the first to fifth and seventh aspects of the invention. In the case of this embodiment, a minimum thickness portion 35 is provided at a distal end portion of an outside seal lip 22b which is referred to as a side lip and which lies in a diametrically outermost position. The minimum thickness portion is formed into a partial circular arc-like shape in section in which an inner circumferential surface side thereof is formed into a convex shape (and an outer circumferential side is formed into a concave surface), and the thickness thereof is made smaller than thicknesses of other portions, so that the outside seal lip 22b is made easy to be elastically deformed around the full circumference thereof. In addition, a sectional shape of the outside seal lip 22b is formed into a wedge shape in which the thickness gradually increases as it extends from the minimum thickness portion 35 towards a distal end portion thereof. Also in the case of this embodiment, a bent portion 34 is formed at a portion of the outside seal lip 22b which lies closer to a distal end thereof, so as to provide a bending point P on an inner circumferential surface of the portion of the outside seal lip 22b which lies closer to the distal end thereof, and an angle of inclination θ₂ of a portion on the inner circumferential surface which lies further distally than the bending point P relative to the center axis is made smaller than an angle of inclination θ₁ of a portion which lies further proximally than the bending point P relative to the center axis (θ₂<θ₁).

In addition, a maximum thickness portion 36 which has a maximum thickness is provided in the vicinity of a distal end portion of the outside seal lip 22b. Furthermore, a portion of the outside seal lip 22b which lies closer to a distal end thereof and further distally than the maximum thickness portion 36 is formed into a tapered shape in which a diametrically outer portion is removed around the full circumference thereof. In addition, an overall shape of the outside seal lip 22b is formed such that it is inclined more in a direction towards a diametrically inside circular ring portion 21 of a slinger 16 (rightwards in FIGS. 5, 6) as it extends towards a distal edge (a diametrically outer edge) thereof.

In the case of a seal ring of this embodiment which is configured as has been described above and a rolling bearing unit with seal rings in which the seal ring is built in, the deformation of the outside seal lip 22b is made to concentrate at the minimum thickness portion 35 which is provided at the proximal end portion, so as to decrease the effect imposed on the contact force at a sliding contact portion between the distal edge of the outside seal lip 22b and a side surface of the diametrically inside circular ring portion 21 of the slinger 16 by a change in an interference of the outside seal lip 22b. Because of this, irrespective of assembling error or the inclination of the center axis of the hub 2 generated in association with the turning of the vehicle, a change in contact force at the sliding contact portion can be decreased further. Consequently, it becomes possible to realize the reduction in frictional resistance at the sliding contact portion and increase in durability of the seal lip while securing the sealing properties sufficiently without excessively increasing the contact force in a neutral state (an initially set state) of the outside seal lip 22b.

The other configurations and functions of the second embodiment are similar to those of the first embodiment that has been described before including the relationship between the contact angles α, β, γ of the respective portions and the like, and therefore, like reference numerals are imparted to like portions to those of the first embodiment, so as to omit the repetition of similar descriptions.

### Third Embodiment

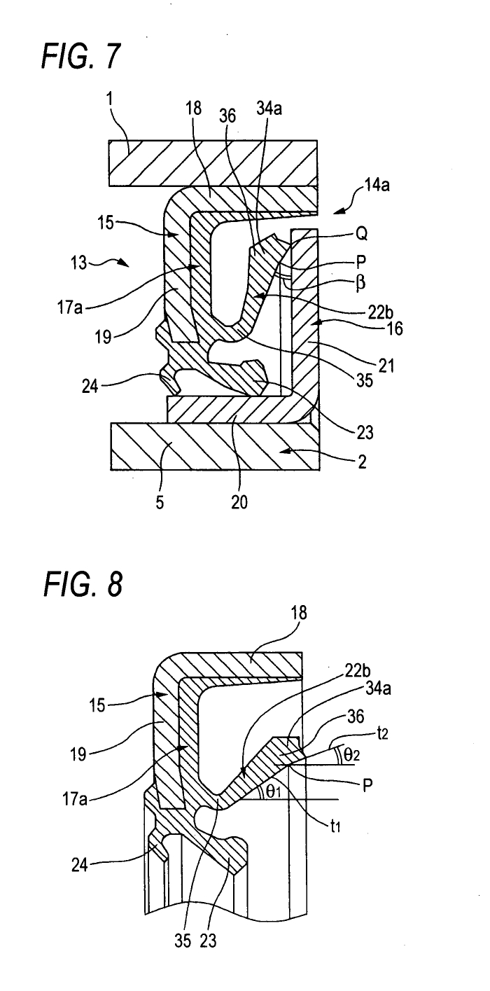

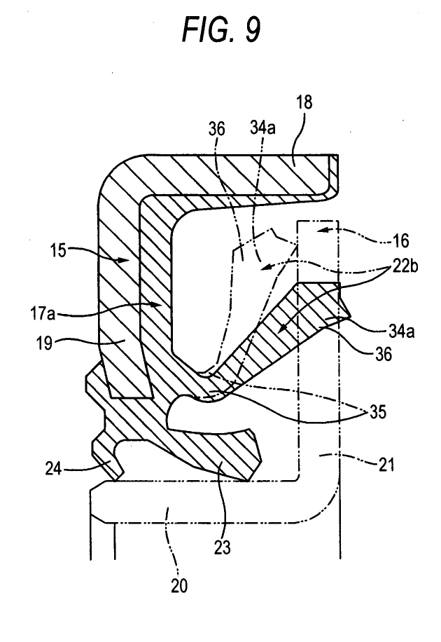

FIGS. 7 to 9 show a third embodiment of the invention which corresponds to the first to seventh aspects of the invention. In the case of this embodiment, as with the second embodiment, a maximum thickness portion 36 is made to lie at a distal end portion of an outside seal lip 22bm and the thickness dimension of the maximum thickness portion 36 is made larger than the thickness of a portion of the outside seal lip 22b which extends from an intermediate portion to a proximal portion. In addition, a minimum thickness portion is provided at the proximal end portion of the outside seal lip 22b. Furthermore, in the case of this embodiment, a distal edge of the outside seal lip 22b is pointed. Namely, an angle γ of a sectional shape (represented in FIGS. 7 to 9) with respect to an imaginary plane which contains a rotational center axis of a hub 2 of a portion of the distal edge of the outside seal lip 22b which is brought into sliding contact with an axial side surface of a diametrically inside circular ring portion 21 of a slinger 16 is made into an acute angle. In the case of this embodiment, this angle γ is made to be less than 90 degrees and furthermore less than 80 degrees. However, in order to secure a minimum required rigidity at the distal edge of the outside seal lip 22b, a minimum value of the angle γ is preferably 60 degrees or more and more preferably 70 degrees or more.

In the case of this embodiment which has the configuration described above, the sliding contact state between the outside seal lip 22b and the axial side surface of the diametrically inside circular ring portion 21 is stabilized further. Namely, since the maximum thickness portion 36 whose thickness dimension is larger than that of the portion extending from the intermediate portion to the proximal end portion exists at the distal end portion of the outside seal lip 22b, the diameter expansion force at the distal end portion can be increased. In addition, the deformation of the distal end portion is suppressed in such a state that the distal edge of the outside seal lip 22b is pressed against the axial side surface of the diametrically inside circular ring portion 21, and the deformation can be made to concentrate at the portion of the outside seal lip 22b which extends from the proximal end portion to the intermediate portion, in particular, to the minimum thickness portion 35. Because of this, the sliding contact state between the outside seal lip 22b and the axial side surface of the diametrically inside circular ring portion 21 is stabilized. In addition, since the distal edge of the outside seal lip 22b is pointed, the angle β formed at the sliding contact portion between the distal edge of the outside seal lip 22b and the axial side surface of the diametrically inside circular ring portion 21 on the side of the interior space becomes easy to be secured. Because of these features of this embodiment, it becomes easy to make the securing of the sealing properties and the suppression of the sliding resistance highly compatible with each other.

The other configurations and functions of the third embodiment are similar to those of the second embodiment that has been described before including the relationship between the contact angles α, β, γ of the respective portions and the like, and therefore, like reference numerals are imparted to like portions to those of the second embodiment, so as to omit the repetition of similar descriptions.

### Fourth Embodiment

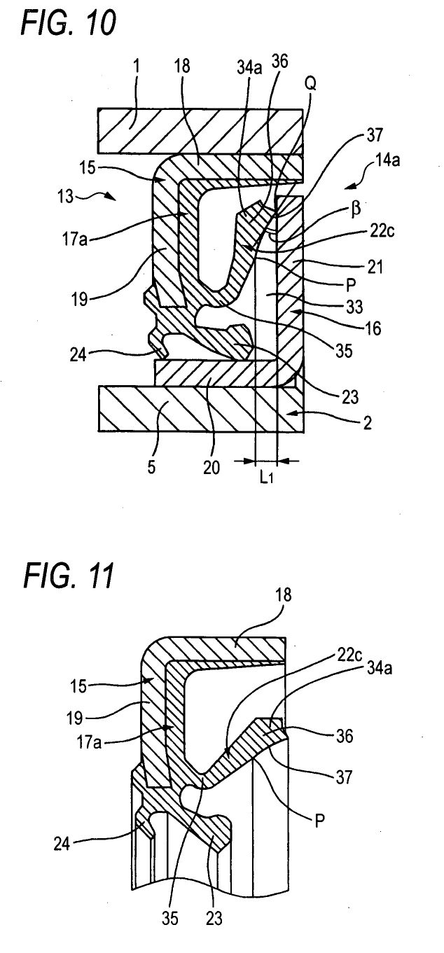

Next, FIGS. 10 to 11 show a fourth embodiment of the invention which also corresponds to the first to seventh aspects of the invention. In the case of this embodiment, a recessed curved surface portion 37 whose sectional shape is a partially recessed circular arc shape is formed on an inner circumferential surface of an end half portion of an outside seal lip 22c. Also in the case of this embodiment that is configured like this, as with the respective embodiments that have been described above, the reduction of the axial length of the seal device which includes the outside seal lip 22c can be realized while securing the lengthwise dimension thereof, and a value of 13 degrees or more can be secured as the contact angle β formed at the sliding contact portion between the outside seal lip 22c and an axial side surface of a diametrically inside circular ring portion 21 of a slinger 16 on the side of an interior space 33. In addition, even in the event that an interference of the outside seal lip 22c relative to the slinger 16 is slightly increased, the value of 13 degrees or more can be secured as the contact angle β, thereby making it possible to bring the distal edge of the outside seal lip 22c into contact with the side surface of the diametrically inside circular ring portion 21 at an extremely narrow area.

The other configurations and functions of the fourth embodiment are similar to those of the second embodiment shown in FIGS. 5 to 6 that has been described before or the third embodiment shown FIGS. 7 to 9 that has been described before, and therefore, like reference numerals are imparted to like portions to those of the second embodiment or the third embodiment, so as to omit the repetition of similar descriptions.

### Fifth Embodiment

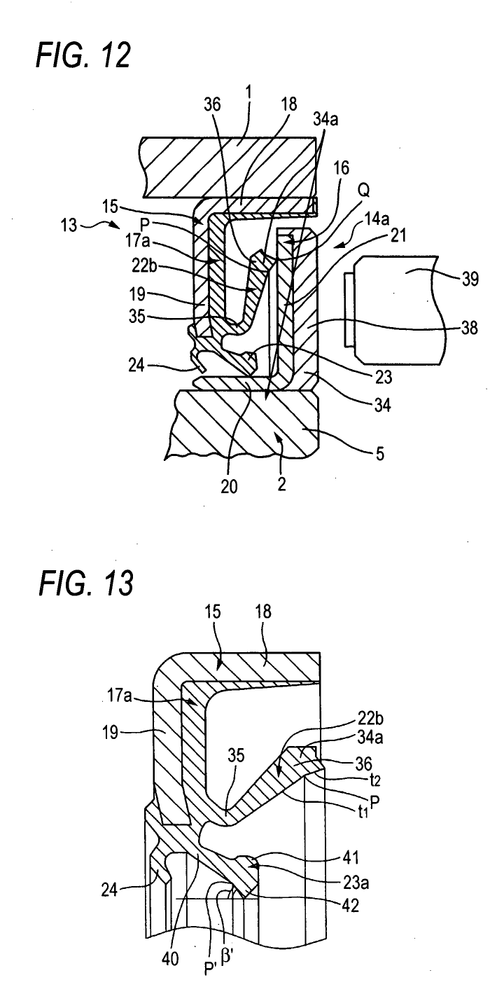

Next, FIG. 12 shows a fifth embodiment of the invention which also corresponds to the first to seventh aspects of the invention. In the case of this embodiment, a magnetic encoder 38 is additionally mounted on an internal surface (a right-hand side surface in FIG. 12) and an outer circumferential edge of a diametrically inside circular ring portion 21 which makes up a slinger 16 through bonding, baking or the like. This magnetic encoder 38 is made by adding magnetic fields whose directions differ in an alternate fashion with respect to a circumferential direction to an annular material in which a ferromagnetic powder such as ferrite is mixed into an elastic material such as an elastomer like a rubber in different directions, and N-poles and S-poles are disposed alternately with respect to the circumferential direction at equal intervals on the axial side surface of the diametrically inside circular ring portion 21. When this seal ring is used on a rolling bearing unit with seal rings, a magnetic sensor 39 is fixed to a portion which is fixed to an outer ring 1, and a detecting portion of this magnetic sensor 39 is made to face a side surface of the magnetic encoder 38 which constitutes a detected portion, whereby the rotational speed of a road wheel fixed to a hub 2 can freely be detected.

The other configurations and functions of the fifth embodiment are similar to those of the second embodiment shown in FIGS. 5 to 6 that has been described before or the third embodiment shown FIGS. 7 to 9 that has been described before, and therefore, like reference numerals are imparted to like portions to those of the second embodiment or the third embodiment, so as to omit the repetition of similar descriptions.

### Sixth Embodiment

Next, FIG. 13 shows a sixth embodiment of the invention which also corresponds to the first to seventh aspects of the invention. In the case of this embodiment, among three seal lips 22b, 23a, 24, an overall shape of the intermediate seal lip 23a which is located in an intermediate position in its free state is formed into a shape which becomes diametrically narrow as it extends from a proximal end portion to a distal end portion. In addition, this intermediate seal lip 23a is also formed into a shape in which the thickness of the intermediate seal lip 23a is made to gradually increase as it extends from a minimum thickness portion 40 which is provided at the proximal end portion towards the distal end portion and a maximum thickness portion which has a maximum thickness is provided in the vicinity of the distal end portion. Furthermore, a bent portion 42 is formed at a portion of an intermediate portion of the intermediate seal lip 23a which lies closer to a distal end thereof in such a manner that a distal end side if bent diametrically inwards relative to a proximal end side in such a state that the intermediate seal lip 23a is in its free state. Consequently, a bending point P′ exists at a portion of an intermediate portion on an inner circumferential surface of the intermediate seal lip 23a which corresponds to the bent portion. Consequently, an angle of inclination of the inner circumferential surface of the intermediate seal lip 23a relative to a diametrically inside cylindrical portion 20 (refer to FIGS. 1, 5) which makes up a slinger 16 is made larger at a point lying further distally than the bending point P′ than at a point lying further proximally than the bending point P′. Then, a distal edge of the intermediate seal lip 23a is brought into sliding contact with an outer circumferential surface of the diametrically inside cylindrical portion 20 which makes up the slinger 16.

In the case of this embodiment that is configured as described above, even in the event that a distance between a diametrically outside cylindrical portion 18 which makes up a core metal 15 and the diametrically inside cylindrical portion 20 changes from a proper position, a value of 13 degrees or more can be secured as an angle β′ that is formed between the distal edge of the intermediate seal lip 23a and the outer circumferential surface of the diametrically inside cylindrical portion 20 on the side of an interior space. At the same time, a distance between the inner circumferential surface of the distal end portion of the intermediate seal lip 23a and the outer circumferential surface of the diametrically inside cylindrical portion 20 can be secured sufficiently. In other words, the distal edge of the intermediate seal lip 23a is brought into contact with the outer circumferential surface of the diametrically inside cylindrical portion 20 at an extremely narrow area, whereby other portions than the distal edge on the inner circumferential surface which lie in the vicinity of the distal end portion of the intermediate seal lip 23a can be separated sufficiently from the outer circumferential surface of the diametrically inside cylindrical portion 20. As a result, even in the event that the interference of the intermediate seal lip 23a is increased or a sliding contact portion between the distal edge of the intermediate seal lip portion 23a and the outer circumferential surface of the diametrically inside cylindrical portion 20 gets worn, the floating of the distal edge of the intermediate seal lip 23a can be prevented. In addition, even in the event that the interference is increased, the contact area can be suppressed to a low level, thereby making it possible to realize the increase in durability and reduction in torque.

The other configurations and functions of the fifth embodiment are similar to those of the second embodiment that has been described before or the third embodiment that has been described before, and therefore, like reference numerals are imparted to like portions to those of the second embodiment or the third embodiment, so as to omit the repetition of similar descriptions.

Note that although not shown, the shape of the intermediate seal lip 23a may be restricted to a different shape from the one described in this embodiment. Namely, in the construction of this embodiment, a recessed curved surface portion like the recessed curved surface portion 37 of the fourth embodiment can also be formed on the inner surface portion of an end half portion of the intermediate seal portion 23a. Even in the event that the intermediate seal portion 23a is configured like this, an advantage can be obtained which is similar to that obtained with this embodiment.

### Seventh Embodiment

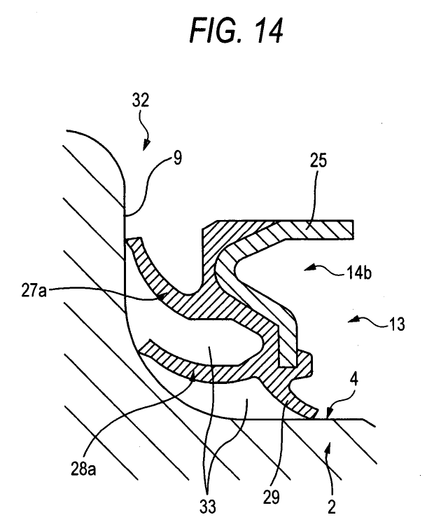

Next, FIG. 14 shows a seventh aspect of the invention which corresponds to the first to third and seventh aspects of the invention. The respective embodiments that have been described heretofore illustrate the case in which the invention is applied to the seal ring 14a (refer to FIG. 1 and the like) which closes a gap between the inner circumferential surface of the inner end portion of the outer ring 1 (refer to FIG. 1 and the like). On the contrary to this, in the case of this embodiment, the invention is applied to a seal ring 14b which closes a gap between an inner circumferential surface of an outer end portion of the outer ring 1 and an outer circumferential surface of a portion of a hub 2 which lies closer to an outer end.

In the case of this embodiment, 13 degrees or more is secured for angles formed at sliding contact portions between distal edges of, among a plurality of (three in the case of the embodiment shown in the figure) outside, intermediate and inside seal lips 27a, 28a, 29, the outside seal lip 27a which lies in a diametrically outermost position and the intermediate seal lip 28a and a surface of the hub 2 on the side of an interior space 33.

As with the constructions of the respective embodiments that have been described heretofore, the construction of this embodiment can realize the increase in the durability of a rolling bearing unit with a seal device and at the same time the increase in the running performance of the vehicle mainly in the areas of fuel economy and acceleration.

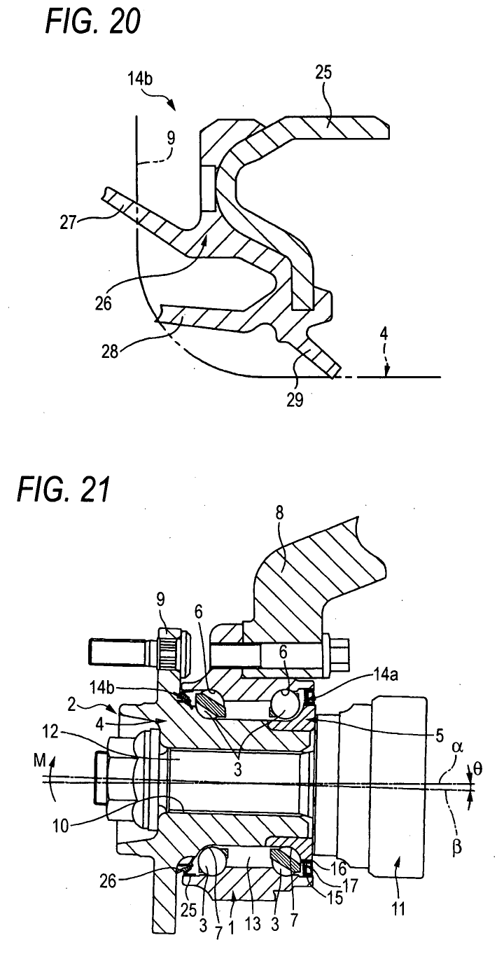

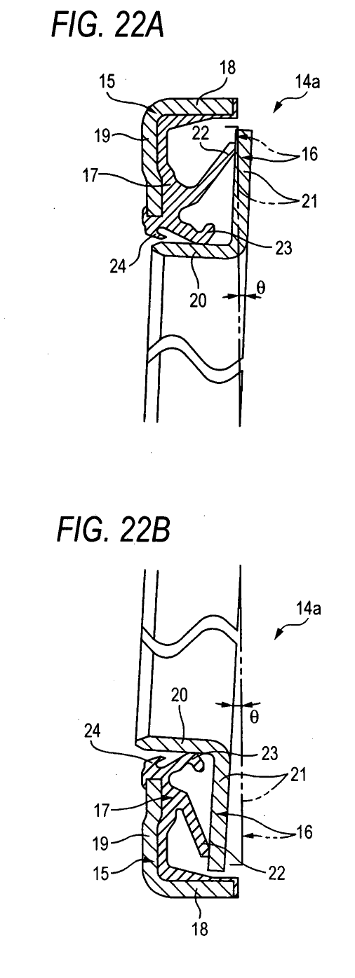

Note that the basic constructions of the respective seal lips 27a, 28a, 29 are similar to those of the related-art seal ring 14b shown in FIGS. 18, 20, and therefore, like reference numerals are given to like constituent portions to those of the related-art seal ring 14b, so as to omit the repetition of similar descriptions.

### EXAMPLE

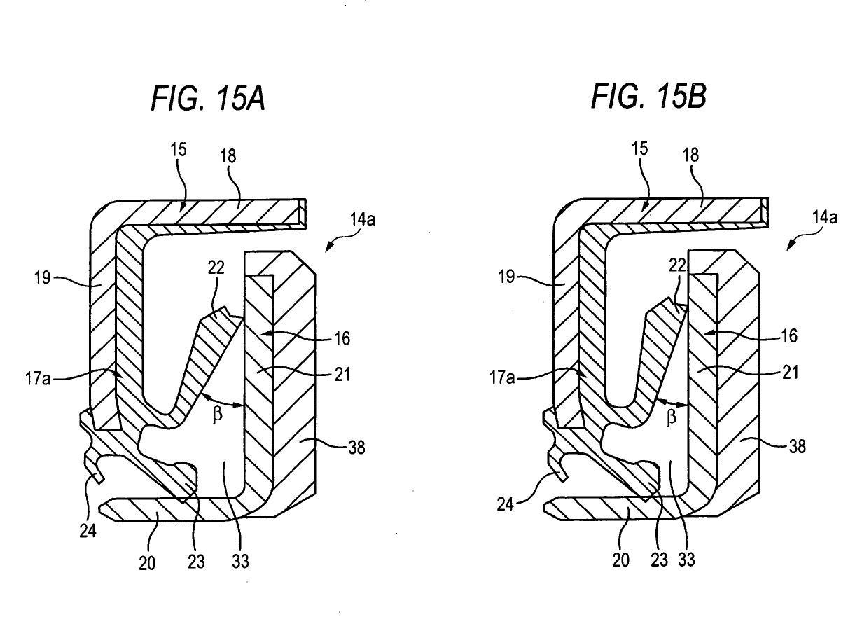

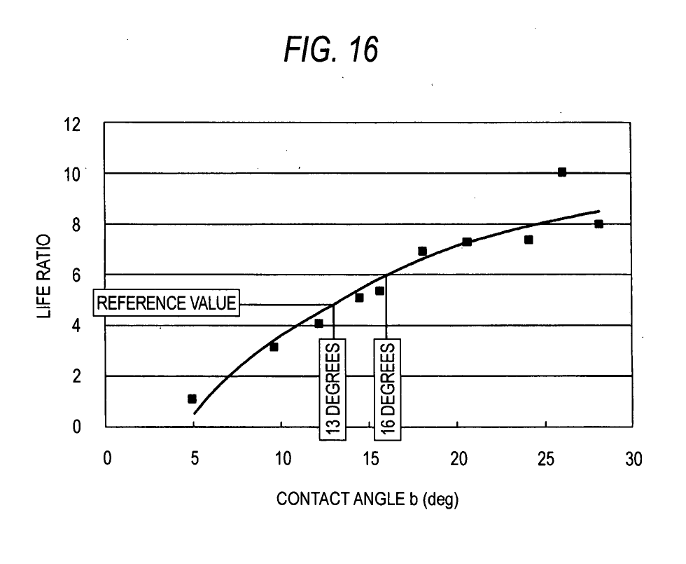

Referring to FIGS. 15 to 16, an experiment will be described which was carried out to verify the securing of the sealing properties by securing 13 degrees or more for the contact angle θ that is formed at the sliding contact portion between the edge of the seal lip and its mating member on the side of the interior space as proposed in the invention.

A seal ring 14a was used which was an assembled seal ring made up of a seal material 17a supported on a core metal 15 and a slinger 16. Then, the experiment was carried out with respect to sealing properties and durability which resulted from various different contact angles β formed at a sliding contact portion between a distal edge of an outside seal lip 22 and a diametrically inside circular ring portion 21 which makes up the slinger 16 on the side of an interior space 33 by changing an axial distance between the diametrically inside circular ring portion 21 and a diametrically outside circular ring portion 19 which makes up the core metal 15 which supports the seal material 17a. Of two types of assembled seal rings shown in FIGS. 15A, 15B, the seal ring shown in FIG. 15A represents a construction which falls within the technical scope of the invention with the contact angle θ being 20.5 degrees, and the seal ring shown in FIG. 15B represents a construction which falls out of the technical scope of the invention with the contact angle β being 9.5 degrees.

Note that the contact angle β cannot be measured from the outside in such a state that the seal material 17a and the slinger 16 are assembled together. Because of this, in the experiment, sectional shapes were measured in such a state that the seal rings were cut by a cutting machine after the constituent components had been assembled together. Once a contact angle β is measured, samples of the same the contact angle β can be obtained based on axial distances between the core metal 15 which supports the seal material 17a and the slinger 16. Separately from this, the contact angle β can be obtained by obtaining sectional shapes by cutting the seal material 17a and the core metal 15 by a cutting machine and carrying out a deformation analysis using an FEM based on a forced amount of the outside seal lip 22.

Assembled seal rings having various different contact angles β in the way described above were built in rolling bearing units to prepare a plurality of samples of different types, and muddy water durability tests were carried out on the respective samples under the following conditions.

Test Cycle: cyclic operation which follows a sequence of “rotation+submersion”->“stop+submersion”->“stop+drying”->“rotation+drying”
Rotational Speed: 1000 min⁻¹
Amount of Eccentricity between Seal Ring and Slinger: 0.4 mmTIR
Submersion Amount of Seal Ring under Muddy Salt Water: up to the axial center

The results of the tests carried out under the test conditions described above are shown in FIG. 16. As is clear from FIG. 16, as the contact angle β formed at the sliding contact portion between the edge of the seal lip and the mating member on the side of the interior space becomes larger, the sealing properties increase further and the durability of the rolling bearing unit increases further. Then, in order to reduce torque while securing the durability required for a rolling bearing unit for supporting a road wheel of a motor vehicle, it was also found that 13 degrees or more needed to be secured for the contact angle β. To speak reversely, in the event that the contact angle β is less than 13 degrees, the sealing properties become insufficient and the increase in the durability of the rolling bearing unit cannot be realized due to the intrusion of water, and additionally, a sufficient advantage cannot be obtained from the viewpoint of torque reduction. In particular, when 16 degrees or more is secured for the contact angle β, a greater advantage can be obtained from the viewpoints of sealing properties and torque reduction.

Note that as to an upper limit for the contact angle β, as is shown in FIG. 17, of angles (contact angles) formed by the surface of a distal edge of a seal lip 30 and its mating surface 31, a contact angle α formed on the side of an exterior space 32 is made larger than a contact angle β formed on the side of an interior space 33 (α>β), so that the contact angle β is suppressed to 45 degrees or below from the viewpoints of securing the sealing properties.

While the invention has been described in connection with the exemplary embodiments, it will be obvious to those skilled in the art that various changes and modification may be made therein without departing from the present invention, and it is aimed, therefore, to cover in the appended claim all such changes and modifications as fall within the true spirit and scope of the present invention.

What is claimed is:

1. A seal device made of an elastic material for sealing off an interior space defined between primary and secondary members which are adapted to rotate relatively to each other from an exterior space which is defined outside of the interior space, the seal device comprising:
an annular seal lip which is supported on the primary member, wherein
a edge of the seal lip is brought into sliding contact with an entire circumference of a contact surface of the secondary member or a tertiary member which is fixed to the secondary member, and
an angle formed between the edge of the seal lip and the contact surface of the secondary member or the tertiary member on the interior space's side is in the range of 13 to 45 degrees.

2. The seal device as set forth in claim 1, wherein the contact surface of the secondary member or the tertiary member, with which the edge of the seal lip is brought into sliding contact, intersects a rotational center axis of the primary and secondary members at right angles.

3. The seal device as set forth in claim 2, further comprising:
a core metal which is fixedly fitted in a circumferential surface of the primary member, wherein
a proximal end portion of the seal lip is fixedly connected to the core metal, and wherein
the seal lip is formed to have in its free state an overall shape which flares in such a way that its diameter increases from the proximal end portion towards a distal end portion thereof, with a sectional shape of the seal lip along a plane containing the rotational center axis in its free state being such that;
a bending point exists at an intermediate portion of an inner circumferential surface of the seal lip; and
an angle of inclination of the inner circumferential surface relative to the center axis at a point lying further distally than the bending point is made smaller than an angle of inclination of the inner circumferential surface relative to the center axis at a point lying further proximally than the bending point.

4. The seal device as set forth in claim 1, wherein a minimum thickness portion which is the smallest in thickness lies in a vicinity of the proximal end portion of the seal lip.

5. The seal device as set forth in claim 1, further comprising a core metal which is fixedly fitted in a circumferential surface of the primary member, wherein
a distal end portion of the seal lip is fixedly connected to the core metal,
the seal lip is formed to have in its free state an overall shape which flares in such a way that its diameter increases from the proximal end portion towards a distal end portion thereof, with a sectional shape of the seal lip along a plane containing the rotational center axis in its free state being such that;
a bending point exists at an intermediate portion of an inner circumferential surface of the seal lip; and
an angle of inclination of the inner circumferential surface relative to the center axis at a point lying further distally than the bending point is made smaller than an angle of inclination of the inner circumferential surface relative to the center axis at a point lying further proximally than the bending point, and
a minimum thickness portion which is the smallest in thickness lies in a vicinity of the proximal end portion of the seal lip.

6. The seal device as set forth in claim 1, wherein
the thickness of the distal end portion of the seal lip is larger than the thickness thereof from an intermediate portion to the proximal end portion, and
a sectional shape of a portion of the edge of the seal lip which is brought into contact with the contact surface of the secondary member or the tertiary member along an imaginary plane containing the rotational center axis of the primary and secondary members is such that an angle of the portion of the distal edge is made into an acute angle.

7. A rolling bearing unit with a seal device comprising:
an outer ring corresponding member comprising an outer ring raceway on an inner circumferential surface thereof;
an inner ring corresponding member comprising an inner ring raceway on an outer circumferential surface thereof;
a plurality of rolling elements which are rotatably provided between the outer ring raceway and the inner ring raceway; and
a seal device for closing an end opening of a space existing between the inner circumferential surface of the outer ring corresponding member and the outer circumferential surface of the inner ring corresponding member, wherein
the seal device is made up of a seal device as set forth in claim 1.
